(19) United States
(12) Patent Application Publication
(10) Pub. No.: US 2010/0288002 A1
(43) Pub. Date: Nov. 18, 2010

(54) LOCK APPARATUS

(75) Inventors: Yoko Takeuchi, Osaka (JP); Takashi Moriyasu, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/780,129

(22) Filed: May 14, 2010

(30) Foreign Application Priority Data
May 15, 2009 (JP) 2009-118210

(51) Int. Cl. E05B 35/10; G06K 9/00

(52) U.S. Cl. 70/340; 382/103

(57) ABSTRACT

A lock apparatus includes an unlocker. The unlocker unlocks when a coincidence condition is satisfied between: one or at least two registration keys including a master key; and an input key. An adder adds, as the registration key, a desired key when a key adding manipulation is performed in an unlocked state. A controller determines whether or not the unlocking by the unlocker results from a coincidence between the master key and the input key, and starts the adder corresponding to a positive determination result while stops the adder corresponding to a negative determination result.

### CROSS REFERENCE OF RELATED APPLICATION

The disclosure of Japanese Patent Application No. 2009-118210, which was filed on May 15, 2009, is incorporated herein by reference.

### BACKGROUND OF THE INVENTION

1. Field of the Invention

The present invention relates to a lock apparatus. More particularly, the present invention relates to a lock apparatus which unlocks a lock when a predetermined condition is satisfied between an input key and a registration key.

2. Description of the Related Art

According to one example of this type of apparatus, print data is administered by a Print folder arranged in a file server. The Print folder is under a folder of a user A, and locked with a password. When the user A inputs the password on a hybrid machine in order to apply a print instruction, the inputted password is transmitted from the hybrid machine to the file server. When the password is successfully authenticated on the file server, a print data list of the user A is transmitted from the file server to the hybrid machine. When the user A selects desired print data on the print data list, the print data is transmitted from the file server to the hybrid machine. The transmitted print data is printed by the hybrid machine.

However, in the above-described apparatus, it is not assumed that the Print folder is shared among a plurality of users including the user A or the password (key) is additionally issued for the sake of convenience for the plurality of users. In this case, however, if the addition of the key is accepted without further consideration, then the security of a lock function is decreased.

### SUMMARY OF THE INVENTION

A lock apparatus according to the present invention, comprises: an unlocker which unlocks a lock when a coincidence condition is satisfied between: one or at least two registration keys including a master key; and an input key; an adder which adds, as the registration key, a desired key when a key adding manipulation is performed in a state where the lock is unlocked; and a controller which determines whether or not the unlocking by the unlocker results from a coincidence between the master key and the input key, and starts the adder corresponding to a positive determination result while stops the adder corresponding to a negative determination result.

According to the present invention, a lock control program product executed by a processor of a lock apparatus, comprises: a step of unlocking a lock when a coincidence condition is satisfied between: one or at least two registration keys including a master key; and an input key; an adding step of adding, as the registration key, a desired key when a key adding manipulation is performed in a state where the lock is unlocked; and a controlling step of determining whether or not the unlocking by the unlocking step results from a coincidence between the master key and the input key, and starts the adding step corresponding to a positive determination result while stops the adding step corresponding to a negative determination result.

According to the present invention, a lock control method executed by a lock apparatus, comprises: a step of unlocking a lock when a coincidence condition is satisfied between: one or at least two registration keys including a master key; and an input key; an adding step of adding, as the registration key, a desired key when a key adding manipulation is performed in a state where the lock is unlocked; and a controlling step of determining whether or not the unlocking by the unlocking step results from a coincidence between the master key and the input key, and starts the adding step corresponding to a positive determination result while stops the adding step corresponding to a negative determination result.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of the present invention;

FIG. 2 is a block diagram showing a configuration of one embodiment of the present invention;

FIG. 3 is an illustrative view showing one example of a configuration of a table applied to the embodiment in FIG. 2;

FIG. 4 is an illustrative view showing one example of a hierarchical structure of a directory and a folder;

FIG. 5 is an illustrative view showing one example of keys held by an administrator and a member;

FIG. 6 is an illustrative view showing one example of a checking process in the embodiment in FIG. 2;

FIG. 7 is an illustrative view showing another example of the checking process in the embodiment in FIG. 2;

FIG. 8 is an illustrative view showing one example of a key adding process in the embodiment in FIG. 2;

FIG. 9 is an illustrative view showing one example of a display state of an LCD monitor applied to the embodiment in FIG. 2;

FIG. 10 is an illustrative view showing one example of a key changing process in the embodiment in FIG. 2;

FIG. 11 is an illustrative view showing another example of the display state of the LCD monitor applied to the embodiment in FIG. 2;

FIG. 12 is a flowchart showing one portion of an operation of a CPU applied to the embodiment in FIG. 2;

FIG. 13 is a flowchart showing another portion of the operation of the CPU applied to the embodiment in FIG. 2;

FIG. 14 is a flowchart showing still another portion of the operation of the CPU applied to the embodiment in FIG. 2;

FIG. 15 is a flowchart showing yet still another portion of the operation of the CPU applied to the embodiment in FIG. 2; and

FIG. 16 is a flowchart showing another portion of the operation of the CPU applied to the embodiment in FIG. 2.

### DETAILED DESCRIPTION OF THE PREFERRED EMBODIMENTS

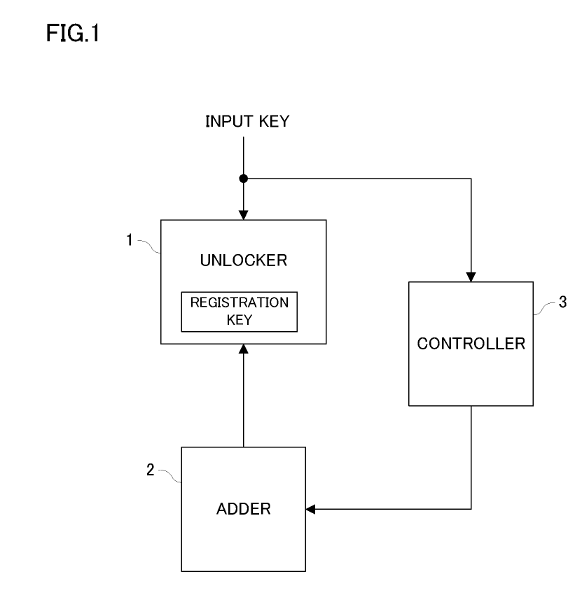

With reference to FIG. 1, a lock apparatus of the present invention is basically configured as follows: An unlocker 1 unlocks when a coincidence condition is satisfied between: one or at least two registration keys including a master key; and an input key. An adder 2 adds, as the registration key, a desired key when a key adding manipulation is performed in an unlocked state. A controller 3 determines whether or not the unlocking by the unlocker 1 results from a coincidence between the master key and the input key, and starts the adder 2 corresponding to a positive determination result while stops the adder 2 corresponding to a negative determination result.

Therefore, if the lock is unlocked resulting from the coincidence between the master key and the input key, then the registration key is added in response to the key adding manipulation. On the other hand, if the lock is unlocked resulting from the coincidence between the registration key different from the master key and the input key, then the addition of the registration key is restricted. As a result, it is possible to add the key capable of unlocking the lock while the security of a lock function is ensured.

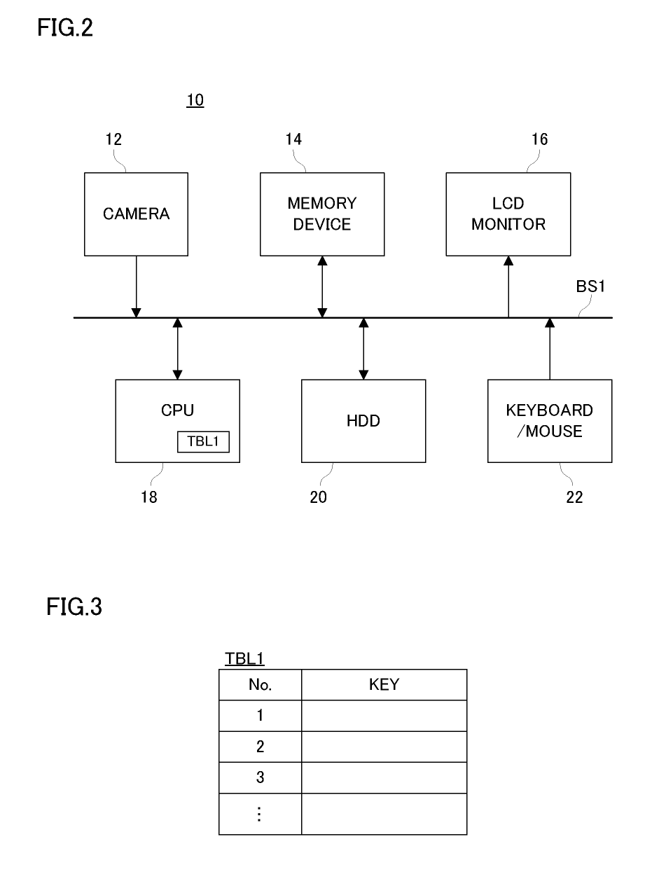

With reference to FIG. 2, a lock apparatus 10 of this embodiment includes a data bus BS1. To the data bus BS1, a camera 12, a memory device 14, an LCD monitor 16, a CPU 18, a HDD 20, and a keyboard/mouse 22 are connected. Moreover, the CPU 18 administers a table TBL1 shown in FIG. 3.

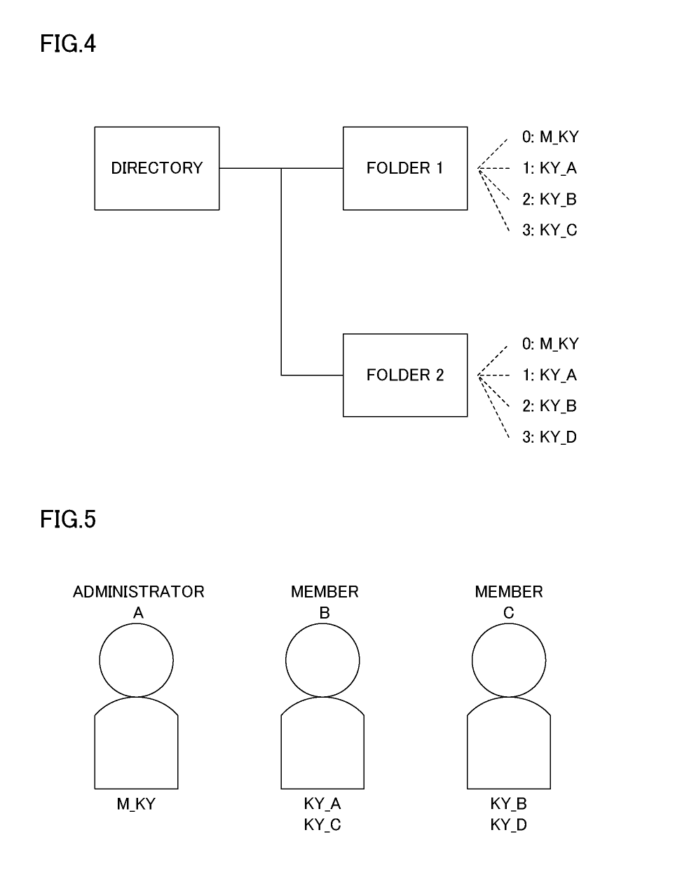

At least one portion of a directory and a folder recorded on the HDD 20 has a hierarchical structure shown in FIG. 4. According to FIG. 4, folders 1 and 2 are arranged at a lower hierarchy of the directory 1. Such a hierarchical structure is displayed on the LCD monitor 16 when the keyboard/mouse 22 is manipulated.

To the folder 1, a master key M_KY, and unique keys KY_A, KY_B, and KY_C are assigned as the registration keys. The master key M_KY has a key number “0”, the unique keys KY_A, KY_B, and KY_C have key numbers “1”, “2”, and “3”, respectively.

To the folder 2, the master key M_KY, and the unique keys KY_A, KY_B, and KY_D are assigned as the registration keys. The master key M_KY has a key number “0”, and the unique keys KY_A, KY_B, and KY_D have key numbers “1”, “2”, and “3”, respectively.

With reference to FIG. 5, an administrator A retains a key that coincides with the master key M_KY. Furthermore, a member B retains two keys that coincide with the unique keys KY_A and KY_C, respectively. Moreover, a member C retains two keys that coincide with the unique keys KY_B and KY_D, respectively.

It is noted that as the master key M_KY and the unique keys KY_A, KY_B, KY_C..., articles that are easily available and that facilitate an image recognition, such as accessories (ex. ring or bracelet), a stationery (ex. fountain pen), cosmetics (ex. lipstick), and a portable electronic device (ex. portable telephone receiver) are assumed. Therefore, in this embodiment, the “key” has the same meaning as the article.

In a state where the hierarchical structure shown in FIG. 4 is displayed on the LCD monitor 16 and a manipulator (the administrator A, the member B or the member C) designates the desired folder by using the keyboard/mouse 22, a guidance of “place an input key over a camera” is OSD-displayed on the LCD monitor 16. Then, the manipulator simultaneously places, as the input keys, one or at least two keys equivalent to the master key M_KY or the unique keys KY₁₃ A, KY_B, KY_C . . . over the camera 12.

Image data outputted from the camera 12 is written in the memory device 14. The CPU 18 refers to the master key M_KY or the unique key KY_*(*: A, B, C, . . . ) assigned to the desired folder so as to perform a checking process on the image data accommodated in the memory device 14.

When a key that coincides with the master key M_KY or the unique key KY_* is detected from the image data, a checking result indicates “OK”. On the other hand, unless the key that coincides with the master key M_KY or the unique key KY_* is detected therefrom, the checking result indicates “NG”. When the checking result is “NG”, a predetermined error process is executed, and when the checking result is “OK”, the desired folder is opened. The thus opened folder is closed by a closing manipulation performed toward the keyboard/mouse 22.

The checking process is executed as follows: Firstly, a flag FLGmst is set to “0”, and the key that coincides with the master key M_KY is searched from the image data. When the key that coincides with the master key M_KY is detected from the image data, the checking result is set to “OK”, regarding that the searching is successful. Moreover, in order to declare that the detected input key coincides with the master key, the flag FLGmst is updated to “1”.

Unless the key that coincides with the master key is detected from the image data, variables K and M are set to “0” and “1”, respectively. The variable K is equivalent to a column number of the table TBL1 shown in FIG. 2, and the variable M is equivalent to the key number of the unique key KY_* assigned to the desired folder.

Subsequently, the key that coincides with the unique key KY_* having a key number M is searched from the image data. When the key that coincides with the unique key KY_* having the key number M is detected, the variable K is incremented, and the unique key KY_* having the key number M is written in a column K of the table TBL1. On the other hand, unless the key that coincides with the unique key KY_* having the key number M is detected, the process for incrementing the variable K and the process for writing into the table TBL1 are omitted. Such a key searching process is repeatedly executed until the variable M reaches a maximum value Mmax (the number of unique keys KY_* assigned to the desired folder).

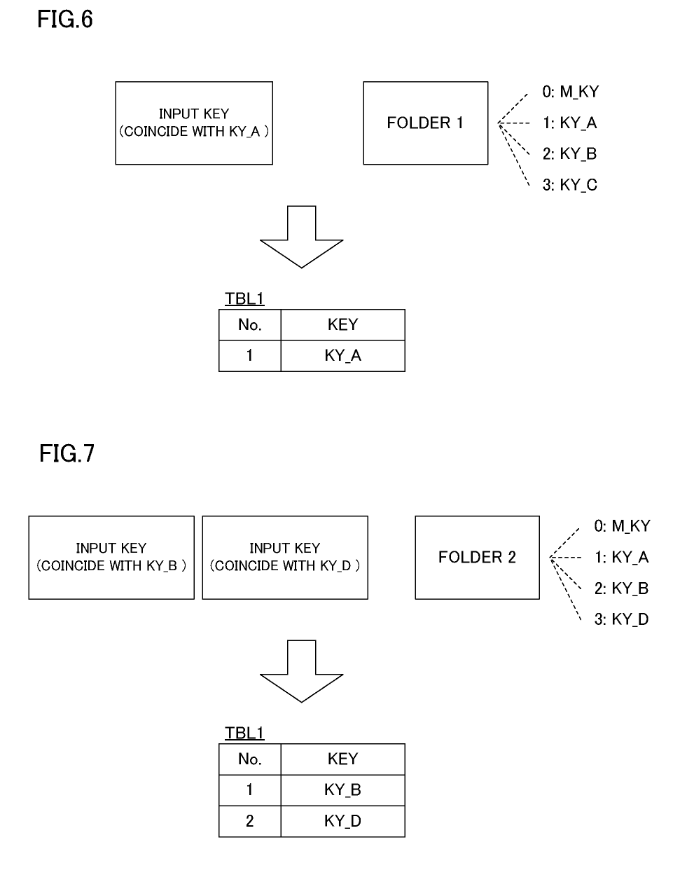

With reference to FIG. 6, when the member B designates the folder 1 and places the key that coincides with the unique key KY_A over the camera 12, this key is detected from the image data and the unique key KY_A is written in the column 1 of the table TBL1. Furthermore, With reference to FIG. 7, the member C designates the folder 2 and simultaneously places the two keys that respectively coincide with the unique keys KY_B and KY_D over the camera 12, these keys are detected from the image data and the unique keys KY_B and KY_D are written in columns 1 and 2 of the table TBL1, respectively.

When the variable M exceeds the maximum value Mmax, it is determined whether or not the variable K (=the number of input keys coincided) is equal to or more than a threshold value TH. When K≧TH is determined, the checking result is set to “OK”, regarding that the coincide condition is satisfied. On the other hand, when K<TH is determined, the checking result is set to “NG”, regarding that the coincide condition is not satisfied.

When the desired folder is in an opened state, the key adding process is executed in response to the key registration manipulation, and a key changing process is executed in response to a key change manipulation. It is noted that the key registration manipulation is permitted when the flag FLGmst indicates “1” while prohibited when the flag FLGmst indicates “0”. Moreover, the key change manipulation is permitted when the flag FLGmst indicates “0” while prohibited when the flag FLGmst indicates “1”.

That is, the key registration manipulation is permitted only when the folder is opened by the coincidence between the master key M_KY and the input key. On the other hand, the key change manipulation is permitted only when the folder is opened by the coincidence between the unique key KY_* and the input key.

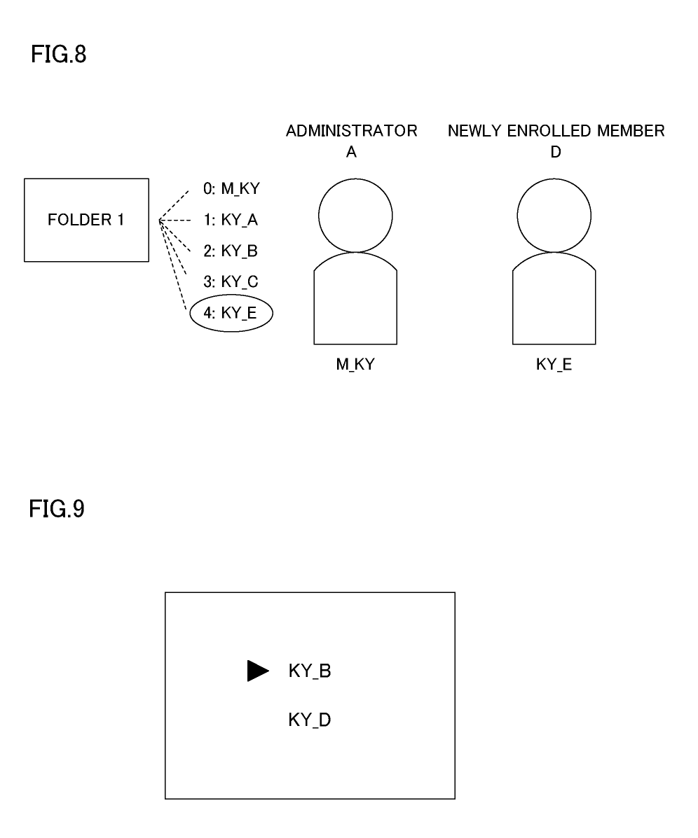

Upon the key adding process, the input key placed over the camera 12 is recognized. The recognized input key is assigned, as an additional unique key KY_*, to the folder in the opened state. Therefore, as shown in FIG. 8, when the administrator A opens the folder 1 and then a newly enrolled member D performs the key registration manipulation and places the key KY_E over the camera 12, the key KY_E is additionally assigned to the folder 1.

Upon the key changing process, the one or at least two unique keys KY_* written into the table TBL1 are listed on the LCD monitor 16. When one of the one or at least two listed unique keys KY_* is selected by the manipulator, the input key placed over the camera 12 at that time point is recognized. Instead of the unique key KY_* selected by the manipulator, the recognized input key is assigned to the desired folder.

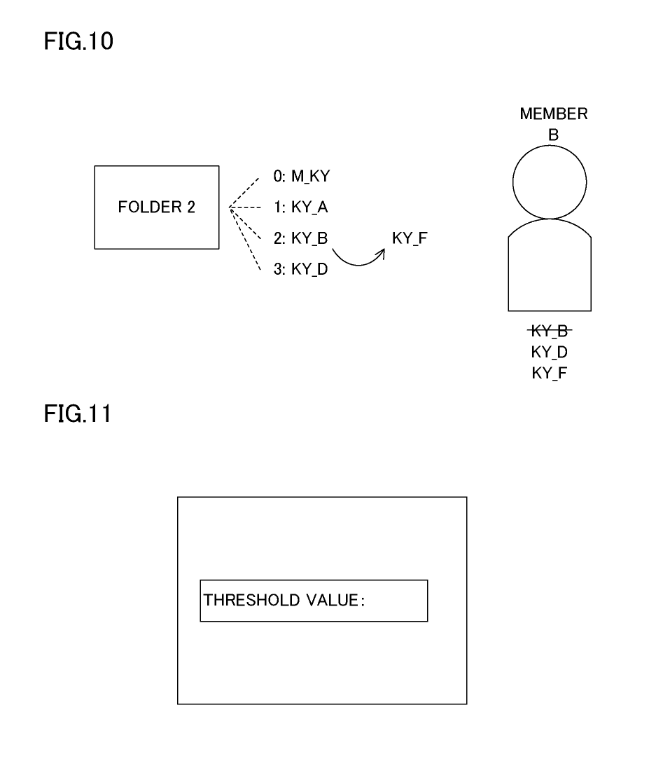

Therefore, when the member B who has opened the folder 2 as shown in FIG. 7 performs the key change manipulation, the unique keys KY_B and KY_D are listed on the LCD monitor 16 as shown in FIG. 9. Herein, if the member B places the key KY_F over the camera 12 and selects the unique key KY_B, then instead of the unique key KY_B, the key KY₁₃ F is assigned to the folder 2, as shown in FIG. 10.

When the folder is in the closed state, a threshold-value input column is displayed on the LCD monitor 16 as shown in FIG. 11, in response to the input of the password by the administrator A. When a threshold-value change manipulation is performed, a magnitude of the above-described threshold value TH is changed. As a result, a content of the coincidence condition is changed. When a completion manipulation is performed, the threshold-value input column is non-displayed.

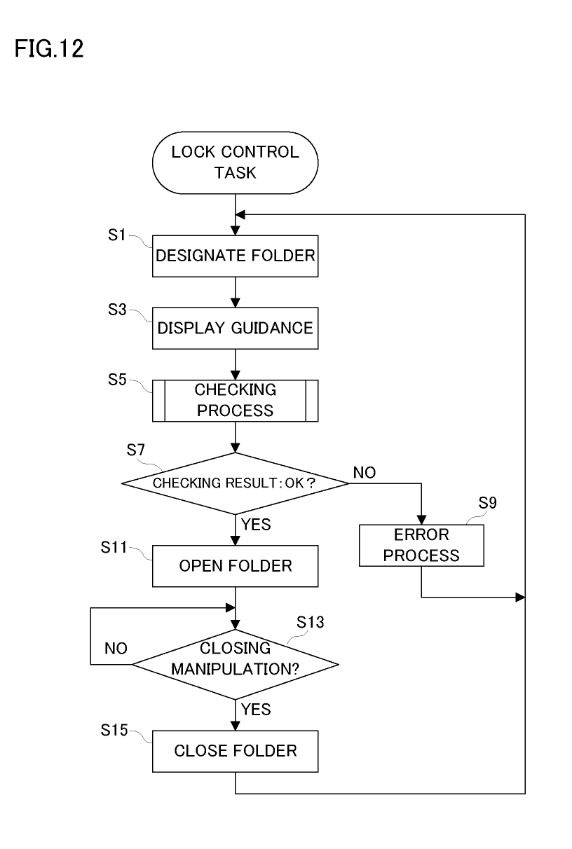

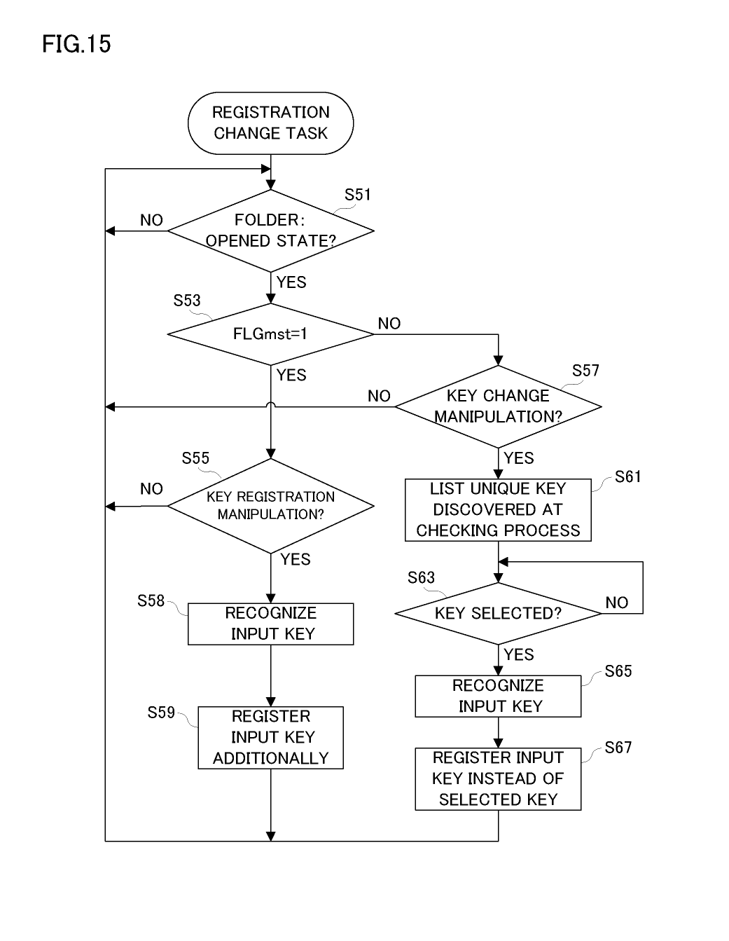

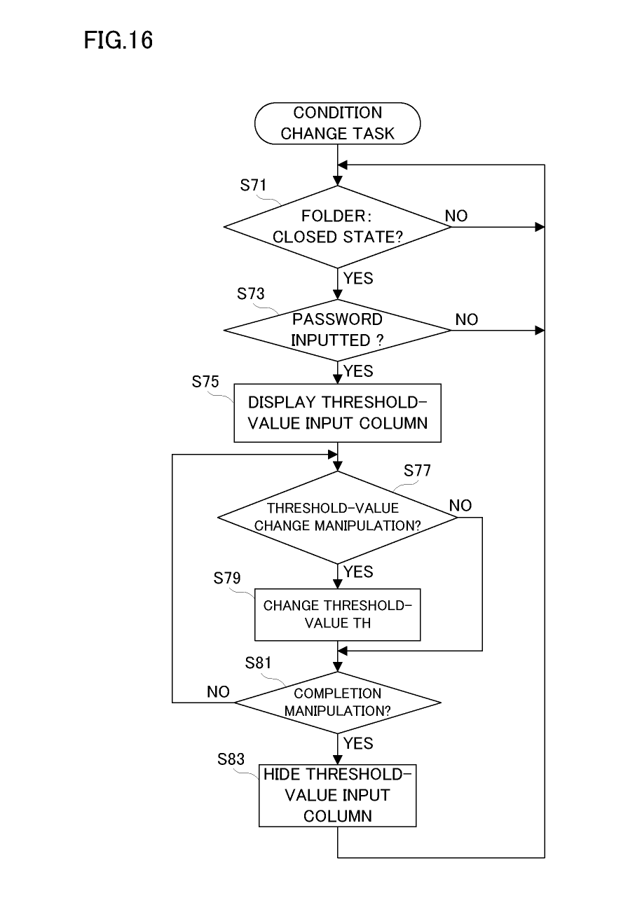

The CPU 18 executes a plurality of tasks including a lock control task shown in FIG. 12 to FIG. 14, a registration change task shown in FIG. 15, and a condition change task shown in FIG. 16, in a parallel manner. It is noted that control programs corresponding to these tasks are stored on the HDD 20.

With reference to FIG. 12, a folder designating process is executed in a step S1. The desired folder is designated by the manipulation of the keyboard/mouse 22 by the manipulator. In a step S3, the guidance of “place the input key over the camera” is OSD-displayed on the LCD monitor 16, and in a step S5, the image data accommodated in the memory device 14 is checked with each of the master key M_KY and the unique key KY_* assigned to the desired folder. When the input key coincides with the master key M_KY or the unique key KY_*, the checking result indicates “OK”. On the other hand, when the input key does not coincides with the master key M_KY or the unique key KY_*, the checking result indicates “NG”.

In a step S7, it is determined whether the checking result indicates “OK” or “NG”. When the checking result is “NG”, an error process is executed in a step S9, and thereafter, the process returns to the step S1. When the checking result is “OK”, the process advances to a step S11 so as to open the desired folder. In a step S13, it is determined whether or not the closing manipulation is performed. When the determination result is updated from NO to YES, the opened desired folder is closed in a step S15, and thereafter, the process returns to the step S1.

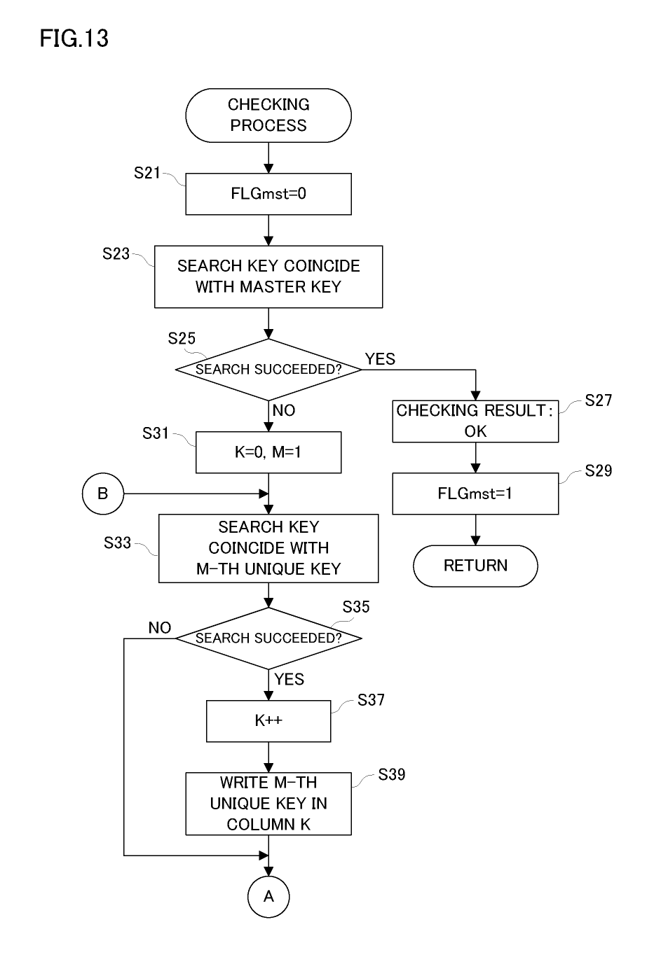

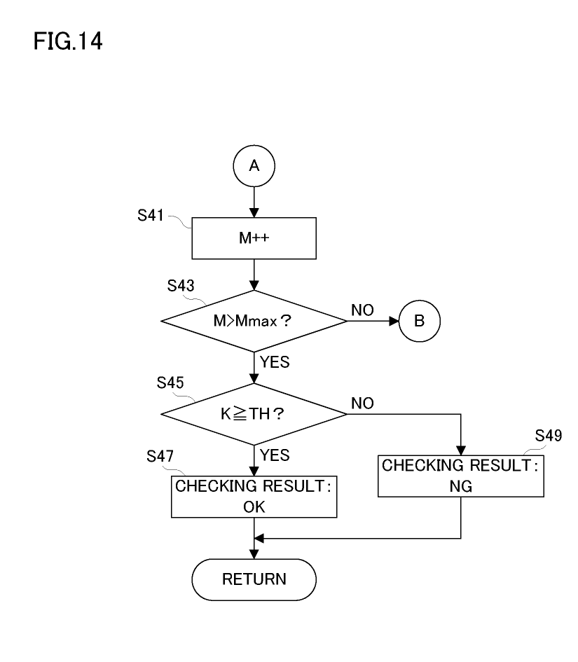

The checking process in the step S5 is executed according to a subroutine shown in FIG. 13 to FIG. 14. Firstly, in a step S21, the flag FLGmst is set to “0”. In a step S23, the key that coincides with the master key M_KY is searched from the image data, and in a step S25, it is determined whether or not the searching is successful. When the key that coincides with the master key M_KY is detected from the image data, YES is determined in the step S25, and the checking result is set to “OK” in a step S27. In a step S29, the flag FLGmst is updated to “1”, and thereafter, the process is restored to a routine at a hierarchical upper level.

When the key that coincides with the master key M_KY is not detected from the image data, the process advances from the step S25 to a step S31 so as to set the variables K and M to “0” and “1”, respectively. In a step S33, the key that coincides with an M-th unique key KY_* is searched from the image data, and in a subsequent step S35, it is determined whether or not the searching is successful.

When the key that coincides with the M-th unique key KY_* is detected from the image data, the variable K is incremented in a step S37, the M-th unique key KY_* is written in the column K of the table TBL1 in a step S39, and thereafter, the process advances to a step S41. On the other hand, when the key that coincides with the M-th unique key KY_* is not detected from the image data, the process directly advances to the step S41.

In the step S41, the variable M is incremented, and in a step S43, it is determined whether or not the incremented variable M exceeds the maximum value Mmax. When a determination result is NO, the process returns to the step S33, and when the determination result is YES, the process advances to a step S45. In the step S45, it is determined whether or not the variable K is equal to or more than the threshold value TH. When a determination result is YES, the checking result is set to “OK” in a step S47. When the determination result is NO, the checking result is set to “NG” in a step S49. Upon completion of the process in the step S47 or S49, the process is restored to the routine at a hierarchical upper level.

With reference to FIG. 15, it is determined whether or not the folder is in the opened state in a step S51. When the determination result is updated from the NO to YES, it is determined in a step S53 whether or not the flag FLGmst is “1”, it is determined in a step S55 whether or not the key registration manipulation is performed, and it is determined in a step S57 whether or not the key change manipulation is performed. It is noted the determining process in the step S55 is executed when YES is determined in the step S53, and the determining process in the step S57 is executed when NO is determined in the step S53.

When the determination result in the step S55 is NO, the process directly returns to the step S51, and when the determination result in the step S55 is YES, the process returns to the step S51 after undergoing the processes in steps S58 and S59. Moreover, when the determination result in the step S57 is NO, the process directly returns to the step S51, and when the determination result in the step S57 is YES, the process returns to the step S51 after undergoing the processes in the steps S61 to S67.

In the step S58, the input key is recognized from the image data accommodated in the memory device 14. In the step S59, the recognized input key is additionally assigned, as the unique key KY_*, to the desired folder.

In a step S61, one or at least two unique keys KY_* written in the table TBL1 are listed on the LCD monitor 16. When one of the one or at least two listed unique key KY_* is selected by the manipulator, the process advances from the step S63 to a step S65 so as to execute the recognizing process that is similar to that in the step S58. In a step S67, instead of the selected unique key KY_*, the recognized input key is assigned to the desired folder.

With reference to FIG. 16, it is determined in a step S71 whether or not the folder is in the closed state. When a determination result is NO, the process returns to the step S71, and when the determination result is YES, the process advances to a step S73. In the step S73, it is determined whether or not the password is inputted. When the password is not inputted or the inputted password is not correct, the process returns to the step S71. On the other hand, when the correct password is inputted, the threshold-value input column is displayed on the LCD monitor 16 in a step S75, regarding that a password input person is the administrator A.

In a step S77, it is determined whether or not the threshold-value change manipulation is performed, and when the determination result is NO, the process directly advances to a step S81. On the other hand, when a determination result is YES, the process advances to the step S81 after changing the magnitude of the threshold value TH in a step S79. In the step S81, it is determined whether or not the completion manipulation is performed, and when the determination result is NO, the process returns to the step S77 while when a determination result is YES, the process returns to the step S71 after setting the threshold-value input column to non-display in a step S83.

As can be seen from the above-described explanation, when the coincidence condition is satisfied between one or at least two registration keys including the master key M_KY and the input key placed over the camera 12, the desired folder recorded on the HDD 20 is opened by the CPU 18 (S23 to S27, S31 to S47, S7, and S11). In a state where the desired folder is opened and the key adding manipulation is performed on the keyboard/mouse 22, the CPU 18 adds the desired key as the registration key (S55 to S59). However, it is determined by the CPU 18 whether or not opening of the desired folder results from the coincidence between the master key M_KY and the input key (S29, S53), and the key adding manipulation is permitted corresponding to the positive determination result while it is prohibited corresponding to the negative determination result.

Therefore, when the folder is opened by the coincidence between the master key M_KY and the input key, the registration key is added in response to the key adding manipulation. On the other hand, when the folder is opened by the coincidence between the registration key different from the master key M_KY and the input key, the addition of the registration key is restricted. As a result, it becomes possible to add a key capable of unlocking the folder while ensuring the security of the lock function of the folder.

It is noted that in this embodiment, opening the folder is assumed as a process operation to be locked. However, it may be possible to assume writing prohibition, a specific manipulation, a change of various setting parameters, movement of an operation mode, etc., as the process operation to be locked.

Moreover, the lock apparatus containing a camera locks or unlocks a certain operation, and in this case, a target to be locked or unlocked is not only limited to the lock apparatus itself but also to a separately connected electronic device. Furthermore, a connection manner may be either one of a wire connection or a wireless connection.

In addition, the term “coincide” is capable of being replaced by a term “agree” or “match”.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A lock apparatus, comprising:
an unlocker which unlocks a lock when a coincidence condition is satisfied between: one or at least two registration keys including a master key; and an input key;
an adder which adds, as the registration key, a desired key when a key adding manipulation is performed in a state where the lock is unlocked; and
a controller which determines whether or not unlocking by said unlocker results from a coincidence between the master key and the input key, and starts said adder corresponding to a positive determination result while stops said adder corresponding to a negative determination result.

2. A lock apparatus according to claim 1, wherein said unlocker includes a searcher which searches a key that coincides with the one or at least two registration keys from a camera image, and said adder includes a recognizer which recognizes, as the registration key, an object on the camera image.

3. A lock apparatus according to claim 1, further comprising a designator which designates any one of a plurality of folders each assigned to the one or at least two registration keys, wherein said unlocker executes an unlocking process corresponding to the folder designated by said designator.

4. A lock apparatus according to claim 1, further comprising a key changer which changes the one or at least two registration keys when a key change manipulation is performed in a state where the lock is unlocked, wherein said controller starts or stops said key changer in a complementary manner in response to staring/stopping of said adder.

5. A lock apparatus according to claim 1, further comprising a condition changer which changes a content of the coincidence condition when a condition change manipulation is performed in a state where the lock is set.

6. A lock control program product executed by a processor of a lock apparatus, comprising:
a step of unlocking a lock when a coincidence condition is satisfied between: one or at least two registration keys including a master key; and an input key;
an adding step of adding, as the registration key, a desired key when a key adding manipulation is performed in a state where the lock is unlocked; and
a controlling step of determining whether or not the unlocking by said unlocking step results from a coincidence between the master key and the input key, and starts said adding step corresponding to a positive determination result while stops said adding step corresponding to a negative determination result.

7. A lock control method executed by a lock apparatus, comprising:
a step of unlocking a lock when a coincidence condition is satisfied between: one or at least two registration keys including a master key; and an input key;
an adding step of adding, as the registration key, a desired key when a key adding manipulation is performed in a state where the lock is unlocked; and
a controlling step of determining whether or not the unlocking by said unlocking step results from a coincidence between the master key and the input key, and starts said adding step corresponding to a positive determination result while stops said adding step corresponding to a negative determination result.
